(19) United States
(12) Patent Application Publication
(10) Pub. No.: US 2025/0116369 A1
(43) Pub. Date: Apr. 10, 2025

(54) BASE SUPPORTING DEVICE

(71) Applicant: MITUTOYO CORPORATION, Kanagawa (JP)

(72) Inventors: Seiichi HAGIWARA, Tochigi (JP); Kazushi KIKUCHI, Tochigi (JP); Daiki ISHII, Tochigi (JP); Fusa OGANE, Tochigi (JP)

(73) Assignee: MITUTOYO CORPORATION, Kanagawa (JP)

(21) Appl. No.: 18/904,337

(22) Filed: Oct. 2, 2024

(30) Foreign Application Priority Data
Oct. 5, 2023 (JP) 2023-173898

(51) Int. Cl. F16M 11/20

(52) U.S. Cl. CPC F16M 11/2092

(57) ABSTRACT

A working machine (base supporting device) includes a base having an upper surface that defines a horizontal plane including X and Y directions; first supports provided for opposite end portions in the X direction of the base and supporting the base in a Z direction; a second support disposed between the opposite end portions of the base supported by the first supports, supporting the base in the Z direction, and being adjustable in a position in the Z direction at which the base is supported; a deflection detecting section that detects an amount of deflection in the Z direction of the base; and a deflection controlling section that controls the second support, in which the deflection controlling section controls, based on the amount of deflection detected by the deflection detecting section, the second support to make the upper surface parallel to the X direction.

### CROSS REFERENCE TO RELATED APPLICATIONS

The entire disclosure of Japanese Patent Application No. 2023-173898 filed Oct. 5, 2023 is expressly incorporated by reference herein.

### TECHNICAL FIELD

The present invention relates to a base supporting device that suppresses deflection of a base on which a target object is to be placed.

### BACKGROUND ART

In measuring or machining a target object, the target object is typically placed on a base or a stage (also including a moving stage) provided on the base to perform a measurement process or a machining process.

For instance, a device described in Literature 1 (JP 2014-85504 A) includes a linear guide extending in a Y direction and disposed on an upper surface of a stage surface plate via vibration suppressors and a first stage movably supported on the linear guide.

In the device of Literature 1, the stage surface plate (the base) is supported via the vibration suppressors provided at end portions. However, the surface plate may be deflected due to, for instance, the installation environment of the device such as a temperature difference between the upper surface and a lower surface (a floor-surface side) of the surface plate. In particular, in a case where rail(s) are laid on the surface plate and the stage is to be moved on the rail(s), such deflection of the surface plate will cause rail deflection and hampers smooth movement of the stage.

### SUMMARY OF THE INVENTION

An object of the invention is to provide a base supporting device capable of suppressing deflection of a base.

A base supporting device according to an aspect of the present disclosure includes: a base having an upper surface, the upper surface defining a horizontal plane including a first direction and a second direction orthogonal to the first direction; first supports provided for opposite end portions in the first direction of the base, the first supports supporting the base in a third direction orthogonal to the first direction and the second direction; a second support disposed between the opposite end portions of the base supported by the first supports, the second support supporting the base in the third direction, the second support being adjustable in a position in the third direction at which the base is supported; a deflection detecting section configured to detect an amount of deflection in the third direction of the base; and a deflection controlling section configured to control the second support, in which the deflection controlling section is configured to control, based on the amount of deflection detected by the deflection detecting section, the second support to make the upper surface of the base parallel to the first direction.

In that configuration, the position at which the base is supported by the second support is controlled according to the deflection of the base, thus minimizing the deflection of the base. Accordingly, the deflection of the base is suppressed.

In the base supporting device according to the aspect, it is preferable that the second support includes an active anti-vibration table, the active anti-vibration table including an air damper supporting the base using a pneumatic pressure and a pneumatic pressure adjuster configured to adjust the pneumatic pressure of the air damper, and that the deflection controlling section is configured to control the pneumatic pressure adjuster based on the amount of deflection to adjust the pneumatic pressure.

In that configuration, the second support includes the active anti-vibration table using the air damper, and thus it is possible to easily and accurately adjust the position at which the second support supports the base by the adjustment to the pneumatic pressure.

In the base supporting device according to the aspect, the second support is preferably provided at a position corresponding to a center point of gravity of the base.

When the base is deflected due to its own weight or a temperature difference between the upper and lower portions of the base, a portion with the largest deflection amount is the position corresponding to the center point of gravity. Therefore, providing the second support at the position corresponding to the center point of gravity can effectively suppress the deflection of the base.

The base supporting device according to the aspect may further include: a rail provided for the upper surface, the rail extending along the first direction; a table movable on the rail along the first direction; a table position detecting section configured to detect a position in the first direction of the table; and a support mover configured to cause the second support to move along the first direction with respect to the base, in which the support mover may be configured to cause the second support to move to a position corresponding to the table according to movement of the table in the first direction.

This makes it possible to effectively suppress the deflection of the base at the position of the table. Therefore, it is possible to reduce an increase in a movement load on the table that may otherwise be caused by the deflection of the rail, allowing the table to move smoothly.

The base supporting device according to the aspect may further include: a first temperature sensor configured to measure a temperature of the upper surface; and a second temperature sensor configured to measure a temperature of a lower surface of the base opposite the upper surface, in which the deflection detecting section may be configured to detect the amount of deflection based on first deflection data in which a temperature difference between the upper surface and the lower surface is associated with an amount of deflection of the base and the temperatures measured by the first temperature sensor and the second temperature sensor.

In that configuration, it is possible to easily and quickly detect the amount of deflection of the base attributed to the temperature difference between the upper surface and the lower surface of the base and effectively suppress the deflection of the base.

The base supporting device according to the aspect may further include: a rail provided for the upper surface, the rail extending along the first direction; a table movable on the rail along the first direction; and a table position detecting section configured to detect a position of the table in the first direction, in which the deflection detecting section may be configured to detect the amount of deflection based on second deflection data in which a position in the first direction of the table is associated with an amount of deflection of the base.

The change in the position of the table on the rail results in the change in the deflection state of the base according to the position of the table. In this aspect, a position of the table and a deflection amount are retained in advance as the second deflection data, making it possible to easily and quickly detect the deflection amount corresponding to the position of the table. It is thus possible to suppress the deflection of the base that may otherwise be caused by the movement of the table.

The base supporting device according to the aspect may further include: a second deflection detecting section configured to detect, as a second deflection amount, an amount of deflection in the second direction of the base; and a third support disposed between the opposite end portions of the base supported by the first supports, the third support supporting the base in the second direction, the third support being adjustable in a position in the second direction at which the base is supported, in which the deflection controlling section may be configured to further control, based on the second deflection amount detected by the second deflection detecting section, the third support to make the base parallel to the first direction.

In that configuration, the deflection in the third direction of the base can be suppressed by the second support and the deflection in the second direction of the base can be suppressed by the third support.

### BRIEF DESCRIPTION OF DRAWINGS

FIG. 1 is a perspective view of a schematic configuration of a working machine according to a first exemplary embodiment.

FIG. 2 is a side view of a base of the first exemplary embodiment.

FIG. 3 is a plan view of the base of the first exemplary embodiment.

FIG. 4 is a block diagram of the schematic configuration of the working machine of the first exemplary embodiment.

FIG. 5 is a flowchart illustrating a method of suppressing deflection of the base in the working machine of the first exemplary embodiment.

FIG. 6 is a block diagram of a schematic configuration of a base of a second exemplary embodiment.

FIG. 7 is a flowchart illustrating a method of suppressing deflection of the base in the second exemplary embodiment.

FIG. 8 is a plan view of a schematic configuration of a base according to Modified Example 3.

### DETAILED DESCRIPTION

### First Exemplary Embodiment

Description will be made below on a first exemplary embodiment of the invention.

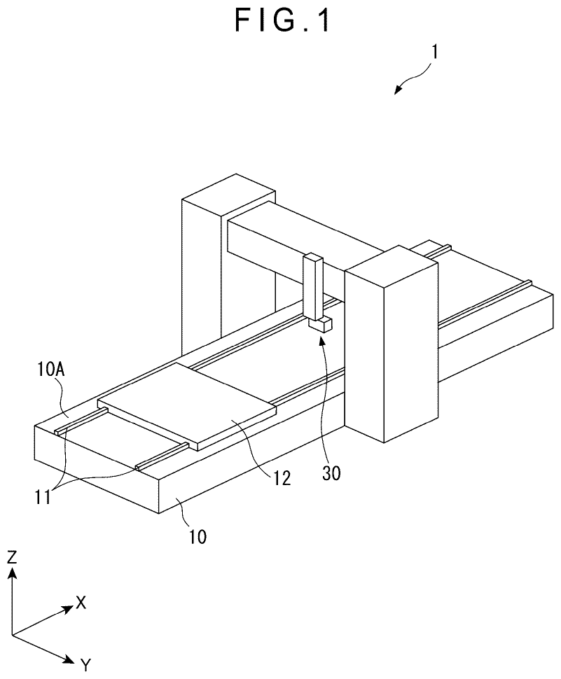

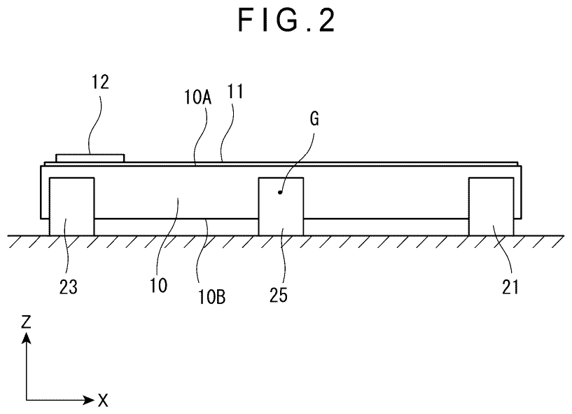

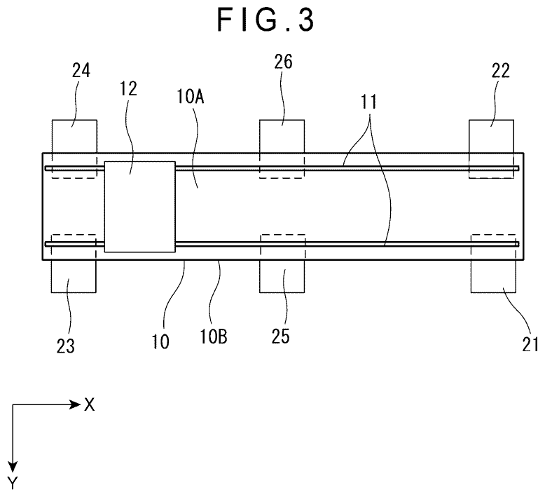

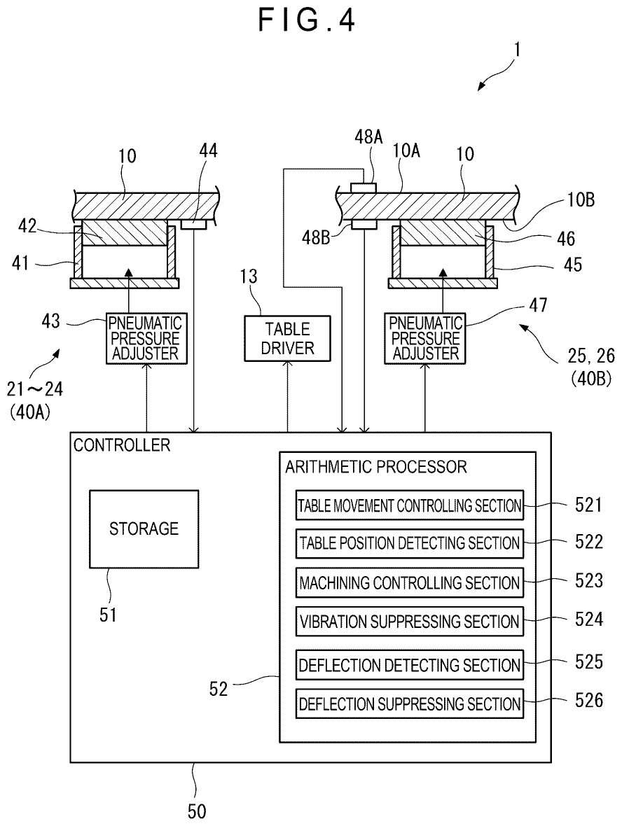

FIG. 1 is a perspective view of a schematic configuration of a working machine 1 according to the first exemplary embodiment. The working machine 1 includes a base supporting device of the invention. FIG. 2 is a schematic side view of a base 10 as viewed from a +Y side along a Y direction. FIG. 3 is a schematic plan view of the base 10 as viewed from a +Z side along a Z direction. FIG. 4 is a block diagram illustrating a control configuration of the working machine 1.

### Overall Configuration of Working Machine 1

The working machine 1 of the exemplary embodiment includes the base 10, first supports 21 to 24 (see FIGS. 2 to 4) and second supports 25 and 26 (see FIGS. 2 to 4) supporting the base 10, a machining unit 30, and a controller 50 (see FIG. 4).

In the exemplary embodiment, rails 11 are laid on an upper surface 10A of the base 10 and a workpiece (not illustrated) is to be placed on a table 12 movably provided on the rails 11. The table 12 with the workpiece placed thereon is to be moved to a predetermined position and subjected to a machining process (for instance, severing, cutting, polishing, exposure, heating, or the like) by the machining unit 30.

The machining unit 30 is not limited in configuration and only has to have a structure suitable for a machining process to be performed, and thus a detailed description thereof will be omitted here. Although the working machine 1 including the base supporting device is described by way of example in the exemplary embodiment, the base supporting device of the invention is not limited to such a working machine 1. For instance, the base supporting device of the invention may be used for a measurement device that measures a shape, dimension, or the like of a target object.

The base 10, which is a so-called surface plate, is a horizontal table having the upper surface 10A as a reference plane. A material of the base 10 is not limited and, for instance, cast iron, stones such as granite, ceramics, glass, and the like are usable.

The base 10 has the upper surface 10A defining the reference plane of the working machine 1. Here, in the exemplary embodiment, the reference plane is assumed to be an XY plane parallel to an X direction and the Y direction orthogonal to the X direction. The thickness direction of the base 10 is a vertical direction, which is the Z direction orthogonal to the X direction and the Y direction.

In the exemplary embodiment, the base 10 has a shape elongated in the X direction and the rails 11 along the X direction are laid on the upper surface 10A. The table 12, on which a workpiece is to be placed, is provided on the rails 11 and the table 12 is movable in the X direction along the rails 11. The base 10 further includes a table driver 13 (see FIG. 4) that causes the table 12 to move in the X direction along the rails 11.

The configuration of the table driver 13 to cause the movement of the table 12 is not limited. Although the illustration is omitted, for instance, driving force of an actuator such as an electric motor may be transmitted to an axle provided for the table 12 to move the table 12 along the rails 11. Alternatively, the table 12 may move along the rails 11 by being supported by an air bearing and pushed in the X direction or in a −X direction by driving force of an actuator or the like.

The base 10 is supported by the first supports 21 to 24. Specifically, as illustrated in FIGS. 2 and 3, the first supports 21 and 22 are arranged near +X side corners in the X direction of the base 10, supporting the base 10 in the Z direction. Likewise, the first supports 23 and 24 are arranged near −X side corners of the base 10, supporting the base 10 in the Z direction. Bessel points or Airy points may be used as respective supporting positions in the X direction of the first supports 21 to 24. The four first supports 21 to 24 are provided by way of example in the exemplary embodiment. However, for instance, a configuration in which the first supports 21 and 22 are provided on the +X side and only the first support 23 is provided at a center portion in the Y direction on the −X side, or a configuration in which only the first support 21 is provided at a center portion in the Y direction on the +X side and the first supports 23 and 24 are provided on the −X side, are employable.

The first supports 21 to 24 are active anti-vibration tables.

For instance, as illustrated in FIG. 4, the first supports 21 to 24, which are active anti-vibration tables, each include an air damper 40A. The air damper 40A includes a cylinder 41 connected to the base 10, a piston 42 inserted in the cylinder 41, and a pneumatic pressure adjuster 43 (an electropneumatic regulator) that adjusts a pneumatic pressure in the cylinder 41.

In the exemplary embodiment, a vibration detection sensor 44 is provided for the base 10, a floor surface, or the like. The first supports 21 to 24 are under the control of the controller 50 and feedback control is performed on the pneumatic pressure to be adjusted by the pneumatic pressure adjuster 43 based on the vibration detected by the vibration detection sensor 44 (see FIG. 4). The vibration of the base 10 is thus suppressed by controlling each of the first supports 21 to 24 so as to cancel the vibration of the base 10.

Further, the base 10 is supported by the second supports 25 and 26 arranged between the +X side first supports 21, 22 and the −X side first supports 23, 24.

The second supports 25 and 26 each correspond to a second support of the invention. The second supports 25 and 26 are provided at a position corresponding to a position of a center point of gravity G of the base 10 as viewed from the Y direction, as illustrated in FIG. 2. Although the two second supports 25 and 26 are arranged with the base 10 in between in the Y direction by way of example in the exemplary embodiment, a single second support may be provided at the position corresponding to the center point of gravity G of the base 10. Alternatively, three or more second supports may be provided.

The second supports 25 and 26 are provided by active anti-vibration tables similar to the first supports 21 to 24. For instance, the second supports 25 and 26 each include an air damper 40B. The air damper 40B includes a cylinder 45, a piston 46, and a pneumatic pressure adjuster 47. Here, the first supports 21 to 24 are subjected to the feedback control based on the vibration applied to the base 10, whereas the second supports 25 and 26 are driven based on the amount of deflection (the straightness) of the base 10.

For instance, in the exemplary embodiment, temperature sensors 48A and 48B are respectively provided for the upper surface 10A and a lower surface 10B of the base 10 (see FIG. 4). The controller 50 computes an amount of deflection of the base 10 based on a temperature difference between the upper surface 10A and the lower surface 10B of the base 10 and performs feedback control on the pneumatic pressure adjuster 47 of each of the second supports 25 and 26 based on the amount of deflection. The deflection of the base 10 is thus suppressed by controlling each of the second supports 25 and 26 so as to cancel the deflection of the base 10.

The controller 50, which is a device configured to control the working machine 1, includes, for instance, a storage 51 including a memory or the like and an arithmetic processor 52 including a CPU or the like, as illustrated in FIG. 4. Although only the single controller 50 is provided by way of example in the exemplary embodiment, a controller for controlling the machining unit 30, a controller for controlling the first supports 21 to 24, and a controller for controlling the second supports 25 and 26 may be separately provided.

A variety of programs and a variety of data for controlling the working machine 1 are recorded in the storage 51. In the exemplary embodiment, first deflection data is recorded as the variety of data recorded in the storage 51. The first deflection data indicates a relationship between a temperature difference between the upper surface 10A and the lower surface 10B of the base 10 and an amount of deflection of the base 10 corresponding to the temperature difference. In addition, pneumatic pressure control data indicating a control pressure of the pneumatic pressure adjuster 47 of each of the second supports 25 and 26 corresponding to the amount of deflection is recorded in the storage 51.

The arithmetic processor 52 reads and executes the variety of programs recorded in the storage 51, thereby functioning as a table movement controlling section 521, a table position detecting section 522, a machining controlling section 523, a vibration suppressing section 524, a deflection detecting section 525, a deflection suppressing section 526, and the like.

The table movement controlling section 521 controls the table driver 13 to move the table 12 in the X direction.

The table position detecting section 522 measures a position in the X direction of the table 12 driven by the table driver 13. The position of the table 12 may be calculated, for instance, based on the amount of driving of the table driver 13, or the base 10 may be provided with a detection sensor that detects the position of the table 12. Such a detection sensor may be a laser distance meter that measures the position of the table 12 by, for instance, dividing a laser beam output from a laser source into measurement light and reference light, irradiating a retroreflector provided for the table 12 at a predetermined position with the measurement light, and receiving interfering light between the measurement light reflected from the retroreflector and the reference light.

The machining controlling section 523 controls the machining unit 30 to perform a machining process on a workpiece.

The vibration suppressing section 524 controls the driving of the first supports 21 to 24. That is, the vibration suppressing section 524 performs the feedback control on the pneumatic pressure adjuster 43 of each of the first supports 21 to 24 based on the vibration detected by the vibration detection sensor 44. The case where the arithmetic processor 52 reads and executes a program recorded in the storage 51 to function as the vibration suppressing section 524 is exemplified here. However, the vibration suppressing section 524 may be configured by a feedback circuit that is a hardware component.

The deflection detecting section 525 detects an amount of deflection of the base 10. In the exemplary embodiment, the deflection detecting section 525 detects the deflection of the base 10 based on a temperature difference between the upper surface 10A and the lower surface 10B of the base 10. The deflection detecting section 525 calculates a temperature difference between an upper surface temperature measured by the temperature sensor 48A provided for the upper surface 10A of the base 10 and a lower surface temperature measured by the temperature sensor 48B provided for the lower surface 10B of the base 10.

Further, the deflection detecting section 525 refers to the first deflection data recorded in the storage 51 and reads the amount of deflection of the base 10 corresponding to the calculated temperature difference. The first deflection data may include the amount of deflection corresponding to the temperature difference recorded, or an amount of deflection corresponding to a combination of the upper surface temperature and the lower surface temperature recorded.

The deflection suppressing section 526 performs, based on the detected deflection amount, the feedback control on the pneumatic pressure adjuster 47 of each of the second supports 25 and 26 so as to suppress the deflection of the base 10.

Although the arithmetic processor 52, which is a hardware component, reads software programs recorded in the storage 51 to function as the table movement controlling section 521, the table position detecting section 522, the machining controlling section 523, the vibration suppressing section 524, the deflection detecting section 525, and the deflection suppressing section 526 in the exemplary embodiment, these functional components may be implemented by respective circuits having corresponding functions.

### Method of Suppressing Deflection of Base 10 in Working Machine 1

Next, description will be made on a method of suppressing the deflection of the base 10 in the working machine 1 of the exemplary embodiment.

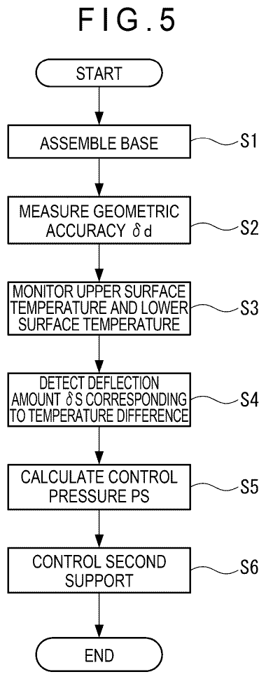

FIG. 5 is a flowchart indicating assembly of the base 10 of the exemplary embodiment.

First, the assembly of the base 10 will be described.

In a case where the working machine 1 is installed in the exemplary embodiment, the first supports 21 to 24 are first assembled and the base 10 is supported by the first supports 21 to 24 (Step S1). For instance, the controller 50 controls the pneumatic pressure adjuster 43 of each of the first supports 21 to 24 to keep the base 10 horizontal.

The deflection of the base 10 at this time is measured as a deflection (a geometric accuracy od) due to a self-weight of the base 10 and recorded in the storage 51 (Step S2). Thereafter, the vibration suppressing section 524 performs the feedback control on the pneumatic pressure adjuster 43 of each of the first supports 21 to 24 based on a signal value output from the vibration detection sensor 44 to suppress the vibration of the base 10.

Next, description will be made on deflection suppressing control on the base 10.

For the base 10 that has been installed as described above, the upper surface 10A is to be used as the reference plane of the working machine 1. The upper surface 10A thus needs to be kept horizontal. For instance, in a case where there is a temperature difference between a temperature of the upper surface 10A and a temperature of the lower surface 10B of the base 10, an amount of expansion/contraction of the upper surface 10A due to thermal expansion is different from an amount of expansion/contraction of the lower surface 10B due to thermal expansion, which causes the base 10 to be deflected in the Z direction. In particular, when the rails 11 are laid on the upper surface 10A as in the exemplary embodiment, the deflection of the base 10 in the Z direction causes the rails 11 on the upper surface 10A to be deflected, leading to an increase in movement load of the table 12 moving on the rails 11 or movement failure of the table 12.

On the contrary, in the exemplary embodiment, the deflection suppressing section 526 of the controller 50 controls the pneumatic pressure adjuster 47 of each of the second supports 25 and 26 so that the deflection δ due to the self-weight is suppressed during the assembly of the base 10 as described above, to minimize a deflection in the Z direction.

Assuming that a deflection in the Z direction of the base 10 is δ, a deflection due to a temperature difference between the upper surface temperature and the lower surface temperature of the base 10 is δS, a deflection due to a reaction force Fr caused by a supply pressure (a control pressure Ps) to the cylinders 45 of the second supports 25 and 26 is δFr, and a deflection due to a variation in the reaction force Fr with a change in an atmospheric pressure P0 is δP0, δ is represented by an expression below.

$$Mathematical Expression 1$$

$$δ = δ d - ( δ S + δ Fr + δ P 0 ) \qquad ( 1 )$$

Here, in Expression (1), δFr+δP0 is determined by the control pressure Ps of the pneumatic pressure adjuster 47 (the electropneumatic regulator). Thus, when δFs+δP0 is replaced by δ(PS) and deflection δ is assumed to be zero, Expression (2) below is derived from Expression (1).

$$Mathematical Expression 2$$

$$δ ( PS ) = δ d - δ S \qquad ( 2 )$$

In the exemplary embodiment, δS is obtainable based on the first deflection data recorded in the storage 51.

That is, the deflection detecting section 525 first monitors the temperatures of the upper surface 10A and the lower surface 10B (the upper surface temperature and the lower surface temperature) of the base 10 using the temperature sensors 48A and 48B (Step S3).

The deflection detecting section 525 then refers to the first deflection data recorded in the storage 51 and reads a deflection amount OS corresponding to a temperature difference between the upper surface temperature and the lower surface temperature (Step S4). The first deflection data may include a deflection amount OS corresponding to a combination of the upper surface temperature and the lower surface temperature as described above. In this case, it is only necessary to read the deflection amount OS corresponding to the combination of the upper surface temperature and the lower surface temperature.

The deflection suppressing section 526 then obtains a deflection δ(PS) to be controlled by the pneumatic pressure adjuster 47 based on Expression (2) and calculates a control pressure PS corresponding to the deflection δ(PS) (Step S5). For instance, the deflection suppressing section 526 reads a control pressure PS corresponding to a deflection amount δ(PS) from the pneumatic pressure control data recorded in the storage 51. The deflection suppressing section 526 then controls the pneumatic pressure adjuster 47 of each of the second supports 25 and 26 with the control pressure PS (Step S6).

The second supports 25 and 26 are thus driven to reduce the deflection of the base 10 that may otherwise be caused by a temperature change, thereby suppressing the deflection of the base 10.

### Workings and Effects of the Exemplary Embodiment

The working machine 1 (the base supporting device) of the exemplary embodiment includes the base 10, the first supports 21 to 24, the second supports 25 and 26, and the controller 50. The base 10 has the upper surface 10A defining a horizontal plane including the X direction and the Y direction. The first supports 21 to 24 are provided for the respective end portions in the X direction of the base 10 to support the base 10 in the Z direction. The second supports 25 and 26 are arranged between the respective end portions of the base 10 supported by the first supports 21 to 24, to support the base 10 in the Z direction and adjust the position in the Z direction at which the second supports 25 and 26 support the base 10. The controller 50 functions as the deflection detecting section 525 that detects an amount of deflection in the Z direction of the base 10 and the deflection suppressing section 526 that controls the second supports 25 and 26. The deflection suppressing section 526 controls the second supports 25 and 26 based on the amount of deflection detected by the deflection detecting section 525 so that the upper surface 10A of the base 10 is parallel to the X direction.

This makes it possible to suppress the deflection of the base 10, and thus makes it possible to inhibit the failure of movement of the table 12 that may otherwise be caused by the deflection of the rails 11, when the rails 11 are laid on the base 10 and the table 12 is moved along the rails 11.

In the working machine 1 of the exemplary embodiment, the second supports 25 and 26 are active anti-vibration tables each including the air damper 40B supporting the base 10 using a pneumatic pressure and the pneumatic pressure adjuster 47 that adjusts the pneumatic pressure of the air damper 40B, and the deflection suppressing section 526 controls the pneumatic pressure adjuster 47 based on an amount of deflection.

Since the second supports 25 and 26 are the active anti-vibration tables each including the air damper 40B, it is possible to easily and accurately adjust the positions at which the second supports 25 and 26 support the base 10 by the adjustment to the pneumatic pressures.

In the working machine 1 of the exemplary embodiment, the second supports 25 and 26 are provided at a position corresponding to the center point of gravity of the base 10.

When the base 10 is deflected due to the self-weight of the base 10 and a temperature difference between the upper surface 10A and the lower surface 10B, a portion with the largest deflection amount is the position corresponding to the center point of gravity. In the exemplary embodiment, the second supports 25 and 26 are provided at the position corresponding to the center point of gravity of the base 10, which makes it possible to effectively suppress the deflection of the base 10.

In the exemplary embodiment, the first temperature sensor 48A that measures the temperature of the upper surface 10A of the base 10 and the second temperature sensor 48B that measures the temperature of the lower surface 10B of the base 10 are provided. The deflection detecting section 525 detects an amount of deflection based on the first deflection data in which a temperature difference between the upper surface 10A and the lower surface 10B is associated with an amount of deflection of the base 10 and the temperatures measured by the first temperature sensor 48A and the second temperature sensor 48B.

This makes it possible to easily and quickly detect the amount of deflection of the base 10 attributed to the temperature difference between the upper surface 10A and the lower surface 10B of the base 10 and effectively suppress the deflection of the base 10 due to the temperature difference between the upper surface 10A and the lower surface 10B of the base 10.

### Second Exemplary Embodiment

Next, description will be made on a second exemplary embodiment.

In the first exemplary embodiment, it is given an example in which a deflection due to a temperature difference between the upper surface temperature and the lower surface temperature of the base 10 is suppressed. However, the deflection of the base 10 may be caused by a weight of the table 12 moving on the rails 11. The second exemplary embodiment is different from the first exemplary embodiment in that a deflection depending on the movement of the table 12 is further suppressed.

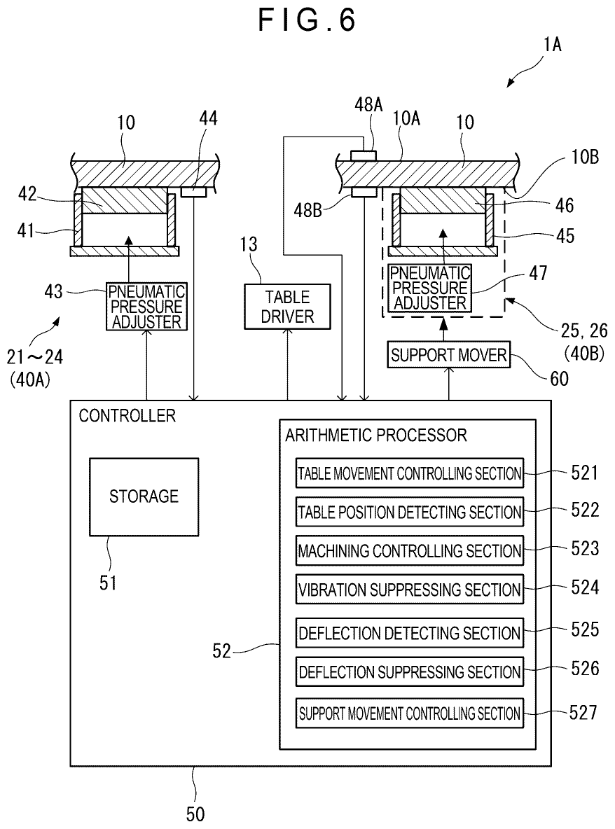

FIG. 6 is a block diagram of a schematic configuration of a working machine 1A, which is a base supporting device of the second exemplary embodiment. It should be noted that the components described above are indicated by the same reference signs, and description thereof is omitted.

The working machine 1A of the exemplary embodiment further includes, in addition to the components of the working machine 1 of the first exemplary embodiment, a support mover 60 that causes the second supports 25 and 26 to move in the X direction.

The support mover 60 may include, for instance, rails laid on a floor surface along the X direction, a mount movable on the rails, and an actuator that causes the mount to move in the X direction. In this case, it is possible to move the second supports 25 and 26 by placing the second supports 25 and 26 on the mount and causing the mount to move via the actuator.

The second supports 25 and 26 are moved by the driving of the actuator, for instance, by reducing the pneumatic pressure of the pneumatic pressure adjuster 47 of each of the second supports 25 and 26 and releasing the support of the base 10 with the second supports 25 and 26.

The controller 50 of the second exemplary embodiment includes the storage 51 and the arithmetic processor 52 as in the first exemplary embodiment. In the second exemplary embodiment, second deflection data is recorded in the storage 51. The second deflection data indicates a relationship between a position in the X direction of the table 12 and an amount of deflection in the Z direction of the base 10.

The arithmetic processor 52 reads and executes the variety of programs recorded in the storage 51, thereby functioning as the table movement controlling section 521, the table position detecting section 522, the machining controlling section 523, the vibration suppressing section 524, the deflection suppressing section 526, and the like as in the first exemplary embodiment and further, functioning also as a support movement controlling section 527.

The support movement controlling section 527 causes the second supports 25 and 26 to move according to a movement destination for the table 12. As for a movement position of the second supports 25 and 26 relative to a movement position of the table 12, the second supports 25 and 26 are to be moved to, for instance, a position in the X direction of the center point of gravity of the table 12. A movable range of the second supports 25 and 26 is a range between the first supports 21, 22 and the first supports 23, 24. That is, the movable range of the second supports 25 and 26 is a range from a −X side end point at which the second supports 25 and 26 are adjacent to the first supports 23 and 24 to a +X side end point at which the second supports 25 and 26 are adjacent to the first supports 21 and 22. Thus, for instance, when the center point of gravity of the table 12 is located on the −X side with respect to the movable range of the second supports 25 and 26, the second supports 25 and 26 are moved to the −X side end point of the movable range. When the center point of gravity of the table 12 is located on the +X side with respect to the movable range of the second supports 25 and 26, the second supports 25 and 26 are moved to the +X side end point of the movable range. When the center point of gravity of the table 12 is between the −X side end point and the +X side end point, the second supports 25 and 26 are moved so that a support center (a center of gravity) of the second supports 25 and 26 corresponds to a position of the center of gravity of the table 12.

The deflection suppressing section 526 of the second exemplary embodiment detects an amount of deflection based on the second deflection data according to the movement of the table 12, and controls the pneumatic pressure adjuster 47 of each of the second supports 25 and 26.

Accordingly, in the second exemplary embodiment, the deflection suppressing section 526 can perform the feedback control to suppress the deflection of the base 10 due to the movement of the table 12.

### Method of Suppressing Deflection of Base 10

Next, description will be made on a method of suppressing the deflection of the base 10 in the working machine 1A of the second exemplary embodiment.

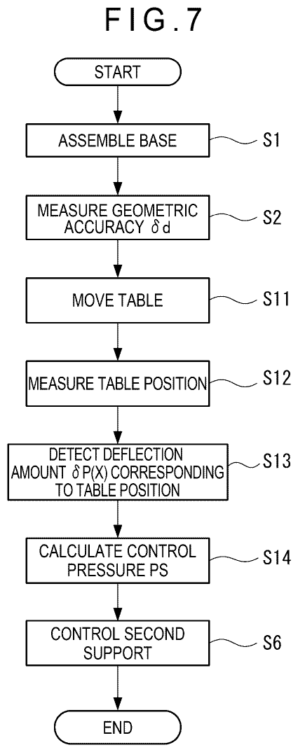

FIG. 7 is a flowchart illustrating deflection suppression control of the second exemplary embodiment.

First, Steps S1 and S2 are performed to assemble the base 10 and the geometric accuracy od of the base 10 is measured as in the first exemplary embodiment.

After that, the table movement controlling section 521 controls the table driver 13 to move the table 12 in the X direction based on, for instance, a predetermined machining process program or based on a manually inputted command (Step S11). The table position detecting section 522 then measures a position in the X direction of the table 12 after movement (Step S12).

Next, the deflection suppressing section 526 reads a deflection amount δP(X) of the base 10 corresponding to a table position measured in Step S12 from the second deflection data recorded in the storage 51 (Step S13).

Assuming that a deflection in the Z direction of the base 10 is δ, a deflection of the base 10 according to a movement position X of the table 12 is δP(X), a deflection due to a reaction force Fr caused by a supply pressure (a control pressure Ps) to the cylinders 45 of the second supports 25 and 26 is δFr, and a deflection due to a variation in the reaction force Fr with a change in an atmospheric pressure P0 is δP0, δ is represented by Expression (3) below.

$$Mathematical Expression 3$$

$$δ = δ d - ( δ P ( X ) + δ Fr + δ P 0 ) \qquad ( 1 )$$

As in the first exemplary embodiment, δFr+δP0 in Expression (3) is determined by the control pressure Ps of the pneumatic pressure adjuster 47 (the electropneumatic regulator). Thus, when δFs+δP0 is replaced by δ(PS) and deflection δ is assumed to be zero, Expression (4) below is derived from Expression (3).

$$Mathematical Expression 4$$

$$δ ( PS ) = δ d - δ P ( X ) \qquad ( 4 )$$

The deflection suppressing section 526 then obtains a deflection δ(PS) to be controlled by the pneumatic pressure adjuster 47 based on Expression (4) and calculates a control pressure PS corresponding to the deflection δ(PS) (Step S14). For instance, the deflection suppressing section 526 reads a control pressure PS for the deflection amount δ(PS) from the pneumatic pressure control data recorded in the storage 51 and performs Step S6 as in the first exemplary embodiment to control the pneumatic pressure adjuster 47 of each of the second supports 25 and 26.

The second supports 25 and 26 are thus driven to reduce the deflection of the base 10 that may otherwise be caused by movement of the table 12, thereby suppressing the deflection of the base 10.

### Workings and Effects of the Exemplary Embodiment

The working machine 1A of the exemplary embodiment achieves workings and effects similar to those of the first exemplary embodiment.

The working machine 1A of the exemplary embodiment includes the rails 11 provided for the upper surface 10A of the base 10 and extending along the X direction, the table 12 movable on the rails 11 along the X direction, and the support mover 60 that causes the second supports 25 and 26 to move along the X direction with respect to the base 10. The controller 50, which also functions as the table position detecting section 522, detects a position in the X direction of the table 12. The support mover 60 causes, under the control of the support movement controlling section 527 of the controller 50, the second supports 25 and 26 to move to a position corresponding to the table 12 according to the movement of the table 12 in the X direction.

That is, in the exemplary embodiment, the second supports 25 and 26 are moved to a position corresponding to the center of gravity of the table 12. This makes it possible to effectively suppress the deflection of the base 10 at the position of the table 12. Therefore, it is possible to reduce an increase in a movement load on the table 12 that may otherwise be caused by the deflection of the rails 11, allowing the table 12 to move smoothly.

In the exemplary embodiment, the deflection detecting section 525 detects an amount of deflection based on the second deflection data in which a position in the X direction of the table 12 is associated with an amount of deflection of the base 10.

When the position of the table 12 on the rails 11 changes as in the exemplary embodiment, the state of deflection of the base 10 may change depending on the position of the table 12. Accordingly, retaining a position of the table 12 and a deflection amount in advance as the second deflection data makes it possible to easily and quickly detect the deflection amount corresponding to the position of the table 12, thereby suppressing of the deflection of the base 10 that may otherwise be caused by the movement of the table 12.

### Modifications

It should be noted that the invention is not limited to the above exemplary embodiments and includes the following modifications as long as the object of the invention is achievable.

### Modification 1

In the first exemplary embodiment, description is made on the configuration in which a deflection of the base 10 attributed to a temperature difference between the upper surface 10A and the lower surface 10B of the base 10 is to be corrected based on the first deflection data. In the second exemplary embodiment, description is made on the configuration in which a deflection of the base 10 attributed to the movement of the table 12 on the rails 11 laid on the upper surface 10A of the base 10 is to be corrected based on the second deflection data.

In this regard, the deflection of the base 10 may be suppressed based on both the temperature of the base 10 and the movement of the table 12. That is, the first exemplary embodiment and the second exemplary embodiment may be combined to suppress the deflection of the base 10 using both the first deflection data and the second deflection data.

In this case, for instance, Expression (2) or Expression (4) may be transformed into Expression (5) below to calculate the control pressure PS for the second supports 25 and 26 using δS detected based on the first deflection data and δP(X) detected based on the second deflection data.

$$Mathematical Expression 5$$

$$δ ( PS ) = δ d - δ S - δ P ( X ) \qquad ( 5 )$$

Alternatively, the amount of deflection of the base 10 corresponding to each X-position of the table 12 may be recorded as the second deflection data for each temperature difference between the upper surface 10A and the lower surface 10B of the table 12.

### Modification 2

In the second exemplary embodiment, the configuration in which the second supports 25 and 26 are moved in the X direction according to the movement of the table 12 is given by way of example, but the invention is not limited thereto.

For instance, in the second exemplary embodiment, the position of the second supports 25 and 26 may be fixed at a position corresponding to the center point of gravity of the base as in the first exemplary embodiment. Although the overall deflection state of the base 10 changes with the movement of the table 12, a part with the largest deflection of the base 10 is near the center point of gravity. It is thus possible to suppress the overall deflection of the base 10 by supporting the center point of gravity with the second supports 25 and 26 and controlling the deflection to be small.

On the other hand, in the first exemplary embodiment, the second supports 25 and 26 may be moved to the position of the table 12 as in the second exemplary embodiment. In this case also, a deflection at the position of the table 12 can be suppressed appropriately to allow the table 12 to move smoothly.

### Modification 3

In the first exemplary embodiment and the second exemplary embodiment, the configuration in which the second supports 25 and 26 supporting the base 10 in the Z direction suppress a deflection in the Z direction of the base 10 is given by way of example.

In this regard, a deflection in the Y direction of the base 10 may be corrected by a third support provided in the Y direction of the base 10.

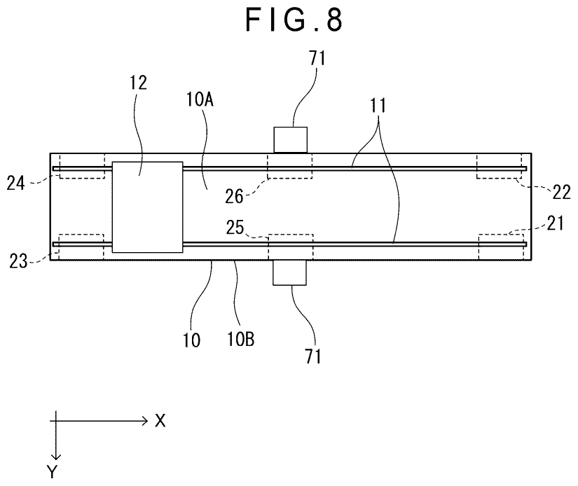

FIG. 8 is a schematic plan view of the base 10 according to Modification 3.

The base 10 illustrated in FIG. 8 is supported with respect to the Z direction by the first supports 21 to 24 and the second supports 25 and 26 as in the first exemplary embodiment and a deflection in the Z direction of the base 10 is suppressed by the second supports 25 and 26.

In addition to the above, the base 10 in FIG. 8 is provided with third supports 71, which support the base 10 in the Y direction, between the opposite end portions of the base 10 at which the first supports 21 to 24 are provided (between a position at which the first supports 21 and 22 are provided and a position at which the first supports 23 and 24 are provided). A pair of third supports 71 are provided with the base 10 therebetween in the Y direction.

The third supports 71, which are active anti-vibration tables as the first supports 21 to 24 and the second supports 25 and 26, each include the air damper and the pneumatic pressure adjuster. The pneumatic pressure adjuster controls a pneumatic pressure of the air damper to move, in the Y direction, a position at which the third supports 71 support the base 10.

In addition, the controller 50 of this example also functions as a second deflection detecting section to detect a deflection in the Y direction of the base 10. As for a method of detecting a deflection in the Y direction of the base 10, for instance, temperature sensors (a third temperature sensor and a fourth temperature sensor) are respectively provided for a +Y side surface and a −Y side surface of the base 10. Third deflection data indicating a deflection in the Y direction of the base 10 corresponding to a temperature difference between the +Y side surface and the −Y side surface of the base 10 is recorded in advance in the storage 51. A deflection in the Y direction of the base 10 is thus detected based on temperatures of the +Y side surface and the −Y side surface measured by the temperature sensors.

The deflection suppressing section 526 then suppresses a deflection in the Z direction of the base 10 as in the first exemplary embodiment or the second exemplary embodiment and controls, based on a deflection in the Y direction of the base 10 detected by the second deflection detecting section, the third supports 71 to suppress the deflection in the Y direction of the base 10.

This makes it possible to suppress not only the deflection in the Z direction but also the deflection in the Y direction of the base 10 according to Modification 3.

For instance, when the base 10 is deflected to be convex toward the +Y side, the pneumatic pressure of the air damper of the third support 71 disposed on the −Y side is reduced to relax a pressing force on the base 10 and the pneumatic pressure of the air damper of the third support 71 disposed on the +Y side is increased, thereby pressing the base 101 toward the −Y side.

The third supports 71 may be movable, for instance, in the X direction according to the position of the table 12 as in the second exemplary embodiment. In this case, the deflection of the rails 11 at the position of the table 12 can be suppressed effectively to allow the table 12 to move smoothly.

### Modification 4

In the first exemplary embodiment and the second exemplary embodiment, it is assumed that a first direction of the base 10 is the X direction and a second direction of the base 10 is the Y direction, and the base 10 is elongated in the X direction by way of example. The invention, however, is not limited thereto.

For instance, a length in the X direction and a length in the Y direction of the base 10 may be the same or substantially the same.

In this case, it is preferable to provide the second support not only at a center portion in the X direction but also at a center portion in the Y direction to suppress the deflection of the base 10.

In the second exemplary embodiment, the configuration in which the rails 11 are laid along the X direction that is a longitudinal direction, and the table 12 is movable in the X direction is given by way of example. The table 12, however, may be movable in both the X direction and the Y direction. In this case, it is preferable that the second support be also movable along the X direction and the Y direction.

### Modification 5

In the above exemplary embodiments, the active anti-vibration tables are used as the first supports 21 to 24 by way of example. The invention, however, is not limited thereto. For instance, the first supports 21 to 24 may be provided by passive anti-vibration tables, or support members with no anti-vibration function may be used.

### Modification 6

In the above exemplary embodiments, the configuration in which the second supports 25 and 26 are provided by the active anti-vibration tables each including the air damper 40B is given by way of example. The invention, however, is not limited thereto. For instance, a driving force of a motor or the like may cause a support shaft supporting the base 10 to advance and retreat to change a supported point of the base 10.

### Modification 7

In the above exemplary embodiments, the base supporting device is exemplified by the working machines 1 and 1A. The base supporting device of the invention, however, is also applicable to any device including the base 10 that defines a horizontal reference plane, as described above. For instance, the base supporting device of the invention is applicable to a measurement device that measures a shape, length, or the like of a measurement target placed on the base 10.

What is claimed is:

1. A base supporting device, comprising:
a base comprising an upper surface, the upper surface defining a horizontal plane comprising a first direction and a second direction orthogonal to the first direction;
first supports provided for opposite end portions in the first direction of the base, the first supports supporting the base in a third direction orthogonal to the first direction and the second direction;
a second support disposed between the opposite end portions of the base supported by the first supports, the second support supporting the base in the third direction, the second support being adjustable in a position in the third direction at which the base is supported;
a deflection detecting section configured to detect an amount of deflection in the third direction of the base; and
a deflection controlling section configured to control the second support, wherein
the deflection controlling section is configured to control, based on the amount of deflection detected by the deflection detecting section, the second support to make the upper surface of the base parallel to the first direction.

2. The base supporting device according to claim 1, wherein
the second support comprises an active anti-vibration table, the active anti-vibration table comprising an air damper supporting the base using a pneumatic pressure and a pneumatic pressure adjuster configured to adjust the pneumatic pressure of the air damper, and
the deflection controlling section is configured to control the pneumatic pressure adjuster based on the amount of deflection to adjust the pneumatic pressure.

3. The base supporting device according to claim 1, wherein the second support is provided at a position corresponding to a center point of gravity of the base.

4. The base supporting device according to claim 1, further comprising:
a rail provided for the upper surface, the rail extending along the first direction;
a table movable on the rail along the first direction;
a table position detecting section configured to detect a position in the first direction of the table; and
a support mover configured to cause the second support to move along the first direction with respect to the base, wherein
the support mover is configured to cause the second support to move to a position corresponding to the table according to movement of the table in the first direction.

5. The base supporting device according to claim 1, further comprising:
a first temperature sensor configured to measure a temperature of the upper surface; and
a second temperature sensor configured to measure a temperature of a lower surface of the base opposite the upper surface, wherein
the deflection detecting section is configured to detect the amount of deflection based on first deflection data in which a temperature difference between the upper surface and the lower surface is associated with an amount of deflection of the base and the temperatures measured by the first temperature sensor and the second temperature sensor.

6. The base supporting device according to claim 1, further comprising:
a rail provided for the upper surface, the rail extending along the first direction;
a table movable on the rail along the first direction; and
a table position detecting section configured to detect a position of the table in the first direction, wherein
the deflection detecting section is configured to detect the amount of deflection based on second deflection data in which a position in the first direction of the table is associated with an amount of deflection of the base.

7. The base supporting device according to claim 1, further comprising:
a second deflection detecting section configured to detect, as a second deflection amount, an amount of deflection in the second direction of the base; and
a third support disposed between the opposite end portions of the base supported by the first supports, the third support supporting the base in the second direction, the third support being adjustable in a position in the second direction at which the base is supported, wherein
the deflection controlling section is configured to further control, based on the second deflection amount detected by the second deflection detecting section, the third support to make the base parallel to the first direction.
